(19) United States
(12) Patent Application Publication
(10) Pub. No.: US 2003/0010140 A1
(43) Pub. Date: Jan. 16, 2003

(54) Device for the measured transfer of several liquids of the same kind

(76) Inventors: Manfred Kopl, Bochum (DE); Jorg Segatz, Paderborn (DE)

Correspondence Address: WITHROW & TERRANOVA, P.L.L.C., P.O. BOX 1287, CARY, NC, 27512, US

(21) Appl. No.: 10/079,234

(22) Filed: May 28, 2002

Related U.S. Application Data
(63) Continuation of application No. 09/214,003, filed on Sep. 9, 1999, now abandoned.

(30) Foreign Application Priority Data
Jul. 2, 1996 (DE) 19626523.1

(51) Int. Cl. G01N 1/26

(52) U.S. Cl. 73/863.31

(57) ABSTRACT

A common liquid measuring device for a plurality of similar fluids, soluble within each other, which, depending on the required fluid, are connected by means of an arrangement of valves to the corresponding supply line between supply tank and fuel dispenser. A screw spindle arrangement is selected as liquid measuring device.

### BACKGROUND OF THE INVENTION

The invention concerns a device for the measured transfer of several liquids of the same kind, in particular a petrol pump for liquid fuels.

Fuel pumps are known from the state of the art. A fuel pump for different types of liquid fuels, such as petrol, contains a plurality of fuel dispensers, such as delivery nozzles, which are fitted to the end of the delivery hose. Each of such fuel dispensers is assigned to a particular type of fuel and each of such fuel dispensers is connected through a supply line to the corresponding supply tank. Interspersed between fuel dispensers and its corresponding supply tank, each supply line contains a delivery pump and an associated measuring device for liquids. If, for example, a petrol pump contains three delivery fuel dispensers for normal petrol, Super and Super Plus, then altogether three measuring devices are in use for types of fuel, which are basically similar. Measuring devices such as these are expensive and require re-calibration from time to time.

### SUMMARY OF INVENTION

According to the invention, a device may be manufactured at lower cost, is smaller in size and simpler to maintain. The invention proposes a common liquid measuring device for a plurality of similar fluids, soluble within each other, which, depending on the required fluid, are connected by means of an arrangement of valves to the corresponding supply line between supply tank and fuel dispenser. The invention recognizes the fact that in the transfer of liquids in a generic device only one fuel dispenser may be in use at any one time, whilst the other fuel dispensers are idle. The display the amount of fuel transferred, a common display is provided. It has been established, that the fuel remaining in the common liquid measuring device remains below the corresponding calibration tolerance, so that it must be acceptable, that someone, who for example draws normal petrol, also receives a small amount of Super petrol, which had been selected by the person before him. For preference, a screw spindle arrangement is selected as liquid measuring device, such as the one described in DE-OS 41 42 062. The clearance volume of the two intermeshing screw spindles, one of which is connected to a rotational counter, is very small and in the order of about 13 cm³. With a typical minimum amount of 51 of fuel dispensed this amount us therefore below the calibration tolerance. In a preferred arrangement of the inventor, a valve has been fitted downstream of each pump and a valve had been fitted upstream of each fuel dispenser, The two resulting arrangements of values, are connected in the shape of a triple-way or multi-way valve. The common liquid measuring device is interspersed between these valve arrangements, so that by suitable setting of the triple-way or multi-way valves the liquid measuring device is connected between a fuel dispenser and its corresponding supply tank. The valve mounted downstream of each pump and the valve mounted upstream of each fuel dispenser may be linked together. In a variation of this arrangement, valves downstream of the measuring device may consist of non-return valves. In another version, valves downstream of the measuring device may be associated with the delivery nozzles, for manual operation. An electronic circuit may then ensure, that, to prevent incorrect operation, the fuel supply is cut off if more than one delivery nozzle is used simultaneously. For such a purpose it could be arranged, that the operation of the manually operated valve contained in the delivery nozzle generates an electric signal, which is taken to a solenoid and which on the simultaneous arrival of two such signals closes the upstream values. This causes in electric blocking. The valves contained in the delivery nozzles could contain a non-return function.

For preference, valves could be constructed in such a manner, that they only open at a predetermined pressure, such as 0.8 bar, to ensure that when operating more than one delivery nozzle, no liquid can emit, since the upstream valve is closed.

An example of the invention is given below with reference to the attached drawings.

### BRIEF DESCRIPTION OF THE DRAWINGS

FIG. 1 is a schematic representation of a device according to the invention, with the example of a fuel pump for three types of liquid fuel.

FIG. 2 is a section through a liquid measuring device, according to DE 41 42 062, as used in the example given in FIG. 1.

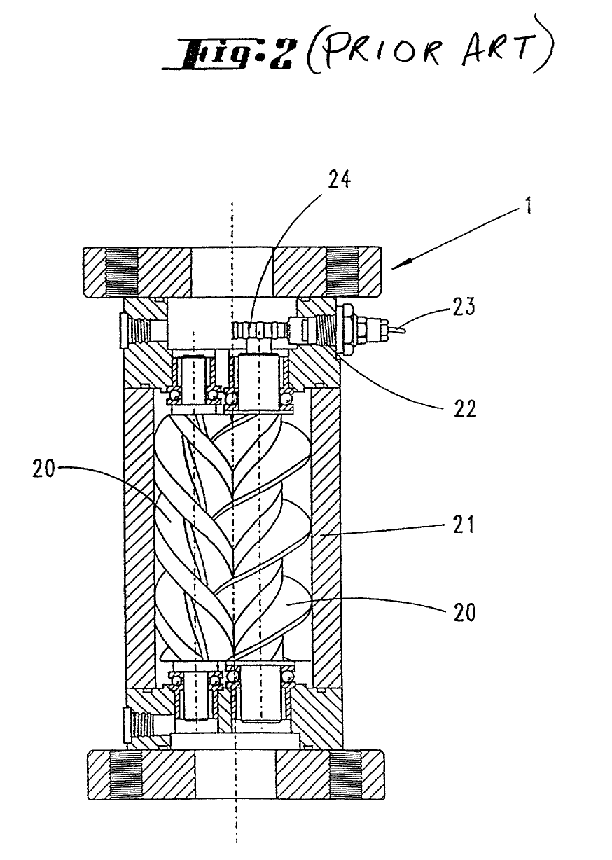

FIG. 3 is a schematic representation of a further example of the invention.

### DETAILED DESCRIPTION OF THE PREFERRED EMBODIMENTS

The liquid measuring device 1 consists of a housing 21, containing two overlapping bores. These cylindrical bores contain intermeshing screw spindles 20, close fitting to the wall of the bores, so that liquid, flowing through the arrangement, causes rotation of the two screw spindles 20. The ends of the spindles are located in bearings, One of the spindles contains a generator wheel 24, designed as pulse generator, which may contain one or several magnets. The housing contains a sensor 22, which cooperates with the signals generated by the generator wheel 24 by means of a magnetic detector, which converts these into electrical signals so that they may be fed by cable 23 to a measurement circuit. In respect of further features of the liquid measurement device, reference is made to DE 41 42 062. The conversion of test values and the display of values of the example correspond to DE 41 52 062, whereby for each completed supply link individual calibration and conversion parameter for volume and price display are provided on the common display unit.

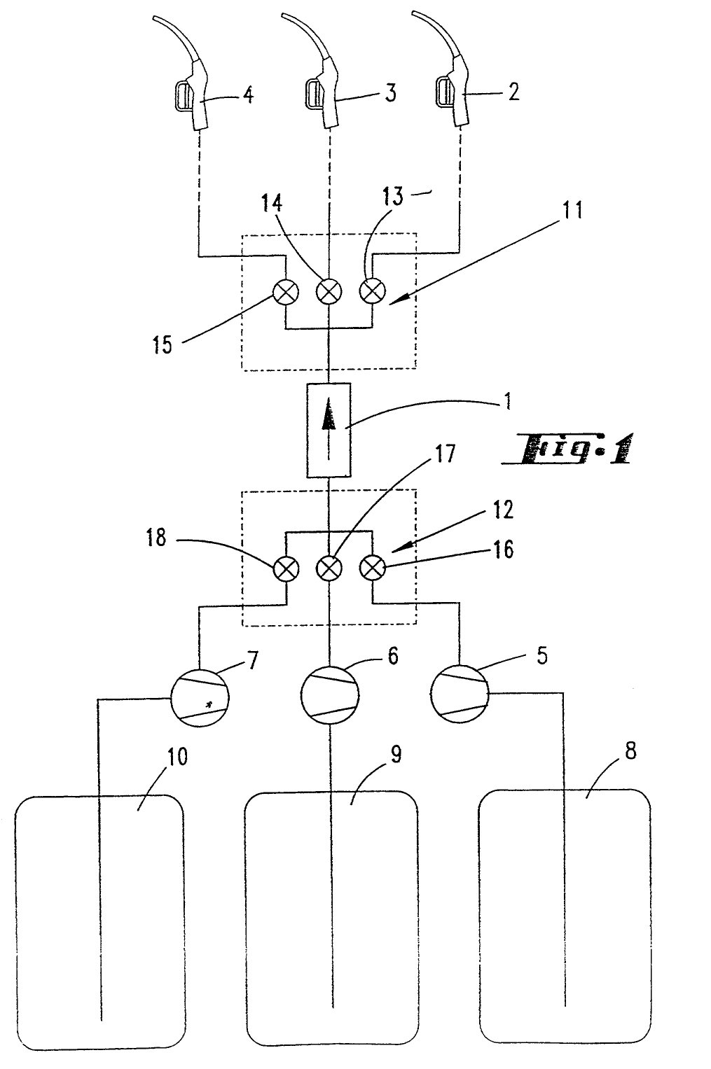

The refueling arrangement given as an example and as depicted in FIG. 1 consists a total of three delivery nozzles 2, 3, 4. Each of these delivery nozzles 2, 3, 4 is connected by means of a hose (not shown) and through valves 13 to 18 to the corresponding pump 5, 6, 7 with its associated supply tank 8, 9, 10.

The outlets of valves 16, 17, 18 downstream of pumps 5, 6, 7, are joined into a common line which feeds into the common liquid measuring device 1, so that on opening valve 18 pump 7 pumps liquid from supply tank 10, on opening of valve 17 pump 6 pumps liquid from supply tank 9 and on opening valve 16 pump 5 pumps liquid from supply tank 8 through the common measuring device. Valves 16, 17, 18 may never be opened together. Only one of these valves may be open at any one time. If valve 16 is opened then valve 13 upstream of fuel dispenser 2 opens. If valve 17 is opened, then valve 14 upstream of fuel dispenser 3 opens. If valve 18 is opened, then valve 15 upstream of fuel dispenser 4 opens. Valves 13, 14, 15, which terminate in their corresponding fuel dispenser, originate from a common input, which is associated with the output of the liquid measuring device 1.

In a special version, valves 16, 17, 18 are combined in a common valve block 12, which is arranged as a multi-way valve. In like manner, valves 13, 14, 15 could be combined in a valve block 11, which is also arranged as multi-way valve. Valves contained in the multi-way valves 11, 12 are switched as pairs, so that the liquid measuring device may be connected into the corresponding supply links between supply tanks 8 to 10 and delivery nozzles 2 to 4.

For preference the volume of the crew spindle counter is below 20 cm³, for preference at 13 cm³, so that when, for example, drawing a minimum of 51 the clearance volume of the liquid measuring device is less than the limits of the calibration tolerance.

The measuring device 1 is connected through a test value converter to a display unit to show the volume drawn and the corresponding price. Simultaneous with the determination and display of the volume, there is the determination and display of the price.

Valves 13, 14, 15 may also be non-return valves or may be contained in the delivery nozzles as manually operated valves.

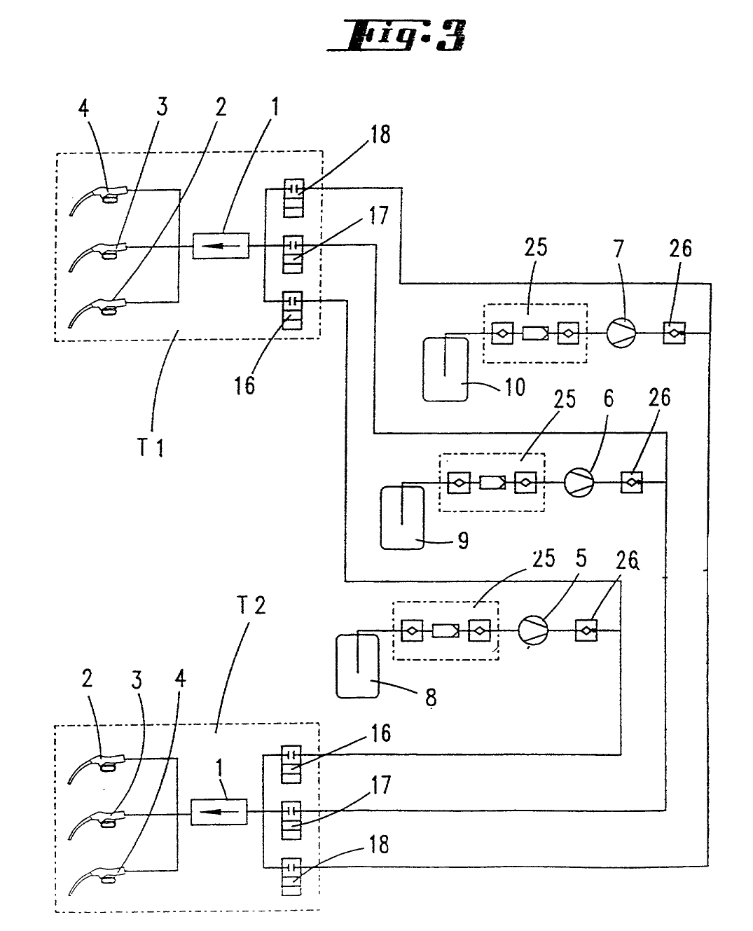

In case of the example of the invention depicted in FIG. 3, two refueling units, 11, 12, are connected to each pump 5, 6, 7. There are altogether three pumps, 5, 6, 7, where each pump is provided with a filter unit 25 through which the liquid, here the fuel, is pumped from the corresponding supply tank 8, 9, 10. Each pump 5, 6, 7 is provided with a non-return valve 26. Downstream of each non-return valve 26 the supply line splits into the two refueling units T1, T2.

In case of the example shown, immediately upstream of the liquid measuring device there are valves 16, 17, 18 associated with the appropriate fuels. Immediately downstream of the liquid measuring device no valves are provided. Instead, downstream valves are contained in the actual delivery nozzles 2, 3, 4. Valves 2, 3, 4 are activated by an operating lever of the delivery nozzle which also operates an electric switch and which signals to an electric circuit—not shown in the representation—that one of the three delivery nozzles 2, 3, 4 has been activated. The electronic circuit opens the corresponding valve 16, 17 or 18 and starts up the corresponding pump 5, 6, or 7 if this is not already operating. The manually operated valves contained in the delivery nozzle are biased in such a way, that they will only open under an admission pressure of at least 0.8 bar.

If in addition to one delivery nozzle being operated a second delivery nozzle is activated, then an electric signal is generated which is fed to the electronic circuit. If the electronic circuit recognizes, that two delivery nozzles are being activated simultaneously, than all upstream valves 16, 17, 18 are being closed to ensure, that fuel may be drawn from one delivery nozzle only at any one time. With valves 16, 17, 18 closed, pressures in the delivery hose falls below the admission pressure so that the manually controlled valves contained in the delivery nozzles remain closed.

All features disclosed are material to the invention. Into the disclosure of the application, the full disclosure contents of the corresponding/enclosed priority documents (copy of earlier application) are deemed to be included, including for the purposes to adopt features contained in such documents into the present application.

In the claims:

1. A device for the metered transfer of two or more liquids each supplied from a respective supply tank by means of a corresponding respective pump to a corresponding respective liquid dispenser comprising:
a common liquid measuring device having a screw spindle arrangement for the fluids;
two or more upstream valves, each providing a supply of one liquid one of the supply tanks to the measuring device; and
two or more downstream valves each providing a supply of one liquid from the measuring device to one of the liquid dispensers, thereby providing a supply link at any one time from one of the pumps through the measuring device and to the corresponding fuel dispenser.

2. A device according to claim 1, wherein a clearance volume of the liquid measuring device is less than a calibration tolerance.

3. A device according to claim 1, wherein a clearance volume of the liquid measuring device is less than 20 cm³.

4. A device according to claim 1, wherein the upstream valves form a first multi-way valve, and the downstream valves form a second multi-way valve.

5. A device according to claim 1, wherein the downstream valves are interconnected in pairs with the upstream valves.

6. A device according to claim 5, wherein the downstream valves are non-return valves.

7. A device according to claim 5 wherein the downstream valves are each associated with a respective liquid dispenser.

8. A device according to claim 1 wherein the liquid dispensers each have a respective manually operated delivery valve and are associated with an electric signal generator which supplies a valve operating to an electronic circuit.

9. A device according to claim 8 wherein the electronic circuit closes all upstream valves when more than one delivery nozzle is activated.

10. A device according to claim 1, wherein the liquids are fuels.
